(19) United States
(12) Patent Application Publication
(10) Pub. No.: US 2015/0185051 A1
(43) Pub. Date: Jul. 2, 2015

(54) ANGLE DETECTION CIRCUIT OF ELECTROSTATIC MEMS SCANNING MIRROR

(71) Applicant: LITE-ON IT CORPORATION, Taipei City (TW)

(72) Inventor: Yu-Nan Tsai, Hsinchu (TW)

(73) Assignee: LITE-ON IT CORPORATION, Taipei City (TW)

(21) Appl. No.: 14/191,472

(22) Filed: Feb. 27, 2014

(30) Foreign Application Priority Data
Dec. 30, 2013 (CN) 201310744347.2

(51) Int. Cl. G01D 5/241

(52) U.S. Cl. CPC G01D 5/2417; G02B 26/0841

(57) ABSTRACT

An angle detection circuit of an electrostatic MEMS scanning mirror is provided. The angle detection circuit includes a capacitance sensing unit, a low-pass filter amplifier unit and an angle determination unit. The capacitance sensing unit is coupled to a mirror electrode of the electrostatic MEMS scanning minor for sensing an equivalent capacitance of the electrostatic MEMS scanning mirror and providing a capacitance sensing signal. The low-pass filter amplifier unit is coupled to the capacitance sensing unit for receiving the capacitance sensing signal and providing a position signal. The angle determination unit is coupled to the low-pass filter amplifier unit for receiving the position signal, and determines a rotation angle of the mirror electrode of the electrostatic MEMS scanning mirror to provide an angle signal.

### CROSS-REFERENCE TO RELATED APPLICATION

This application claims the priority benefit of China application serial no. 201310744347.2, filed on Dec. 30, 2013. The entirety of the above-mentioned patent application is hereby incorporated by reference herein and made a part of this specification.

### BACKGROUND

1. Technical Field

The invention relates to a detection circuit. Particularly, the invention relates to an angle detection circuit of an electrostatic micro-electro-mechanical system (MEMS) scanning mirror.

2. Related Art

A MEMS scanning mirror is an important device for transmitting optical signals and is widely applied to optical-electro-mechanical system integrated products and techniques, such as projectors, barcode readers, optical modulators, optical choppers, optical switches, optical positioning, and so forth. The MEMS scanning minor is composed of an actuator and a plane mirror, the actuator is in charge of applying a force on the plane minor to enable the plane mirror to generate angular displacement so as to reflect an incident optical signal, and a transmission direction of the optical is determined according to the angular displacement of the plane mirror. Methods for driving the MEMS scanning minor are typically classified into an electrostatic, an electromagnetic, a thermo and a piezoelectric methods. Among them, the electrostatic MEMS scanning mirror has advantages, such as greater driving force and better compliance in semiconductor manufacturing processes and thus, have high potential.

In some applications (for example, image projection), a control chip has to be synchronous to a rotation angle of the electrostatic MEMS scanning mirror in order to normally operate. However, according to a current detection technique, the rotation angle of the electrostatic MEMS scanning minor cannot be accurately detected, which slows down development of the electrostatic MEMS scanning mirror. Therefore, how to accurately detect the rotation angle of the electrostatic MEMS scanning mirror is an important issue in development of the electrostatic MEMS scanning minor.

### SUMMARY

The invention provides an angle detection circuit of an electrostatic micro-electro-mechanical system (MEMS) scanning mirror, which is capable of accurately detect a rotation angle of the electrostatic MEMS scanning minor.

The invention directed to an angle detection circuit of an electrostatic MEMS scanning mirror, where a driving electrode of the electrostatic MEMS scanning mirror receives a driving signal. The angle detection circuit includes a capacitance sensing unit, a low-pass filter amplifier unit and an angle determination unit. The capacitance sensing unit is coupled to a mirror electrode of the electrostatic MEMS scanning minor for sensing an equivalent capacitance of the electrostatic MEMS scanning mirror and providing a capacitance sensing signal. The low-pass filter amplifier unit is coupled to the capacitance sensing unit for receiving the capacitance sensing signal and providing a position signal. The angle determination unit is coupled to the low-pass filter amplifier unit for receiving the position signal, and determines a rotation angle of the mirror electrode of the electrostatic MEMS scanning mirror to provide an angle signal.

In an embodiment of the invention, the capacitance sensing unit senses the equivalent capacitance of the electrostatic MEMS scanning mirror according to a coupling current of the mirror electrode and the driving electrode, so as to provide the capacitance sensing signal.

In an embodiment of the invention, the capacitance sensing unit includes a reference voltage, a first diode and a second diode. The reference voltage has a first terminal and a second terminal, and the second terminal receives a ground voltage. A cathode of the first diode is coupled to the mirror electrode and provides the capacitance sensing signal, and an anode of the first diode is coupled to the first terminal of the reference voltage. An anode of the second diode is coupled to the mirror electrode, and a cathode of the second diode is coupled to the first terminal of the reference voltage.

In an embodiment of the invention, the low-pass filter amplifier unit includes an operational amplifier, a first capacitor, a second capacitor, a first resistor, a second resistor, a third resistor, a fourth resistor and a fifth resistor. The operational amplifier has a first input terminal, a second input terminal and an output terminal, where the output terminal provides the position signal. The first capacitor is coupled between the first input terminal and a ground voltage. The first resistor is coupled between the capacitance sensing unit and the first input terminal. The second resistor is coupled between the second input terminal and the output terminal. A terminal of the third resistor is coupled to the second input terminal. The fourth resistor is coupled between the other terminal of the third resistor and a system voltage. The fifth resistor is coupled between the other terminal of the third resistor and the ground voltage. The second capacitor is coupled between the other terminal of the third resistor and the ground voltage.

In an embodiment of the invention, the first input terminal is a positive input terminal, and the second input terminal is a negative input terminal.

In an embodiment of the invention, the angle determination unit determines the rotation angle of the mirror electrode of the electrostatic MEMS scanning mirror according to a voltage level of the position signal.

In an embodiment of the invention, when the voltage level of the position signal presents a falling edge, the angle determination unit determines the rotation angle of the mirror electrode to be 0. When the voltage level of the position signal is at a middle voltage, the angle determination unit sequentially determines the rotation angle of the mirror electrode to be a forward maximum rotation angle and a reverse maximum rotation angle.

According to the above descriptions, in the angle detection circuit of the electrostatic MEMS scanning mirror of the invention, the capacitance sensing unit senses a variation of the equivalent capacitance of the electrostatic MEMS scanning mirror and correspondingly provides the capacitance sensing signal, and the low-pass filter amplifier unit performs a low-pass filtering and amplifying operation on the capacitance sensing signal to convert the capacitance sensing signal into the position signal. In this way, the rotation angle of the electrostatic MEMS scanning mirror can be accurately sensed.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a system schematic diagram of an electrostatic micro-electro-mechanical system (MEMS) scanning mirror and an angle detection circuit according to an embodiment of the invention.

FIG. 1B is a schematic diagram of operation signals of the electrostatic MEMS scanning mirror and the angle detection circuit of FIG. 1A.

FIG. 2A is a circuit schematic diagram of a capacitance sensing unit of FIG. 1A according to an embodiment of the invention.

FIG. 2B is a schematic diagram of a current-voltage characteristic of diode according to an embodiment of the invention.

FIG. 3 is a circuit schematic diagram of a low-pass filter amplifier unit of FIG. 1A according to an embodiment of the invention.

### DETAILED DESCRIPTION OF DISCLOSED EMBODIMENTS

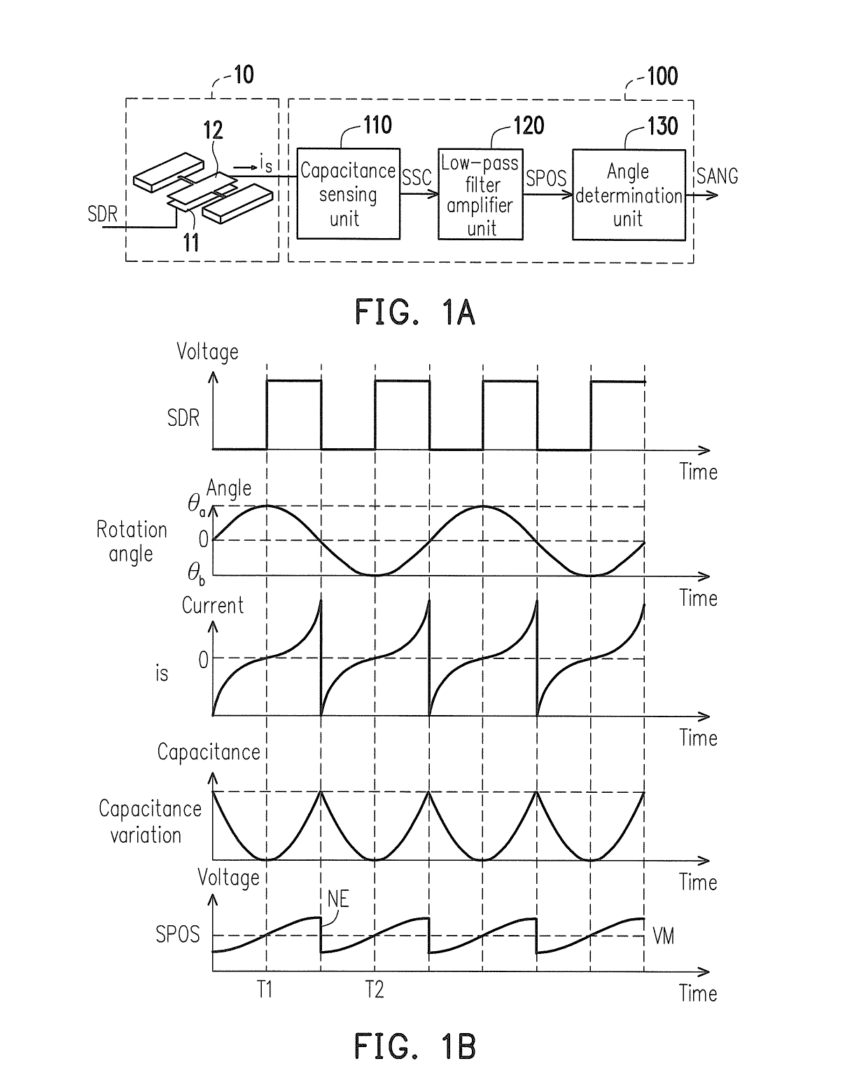

FIG. 1A is a system schematic diagram of an electrostatic micro-electro-mechanical system (MEMS) scanning mirror and an angle detection circuit according to an embodiment of the invention. Referring to FIG. 1A, in the present embodiment, the electrostatic MEMS scanning mirror 10 includes a driving electrode 11 and a mirror electrode 12, where the driving electrode 11 is configured to receive a driving signal SDR to generate an electric field corresponding to the driving signal SDR, and the mirror electrode 12 inducts the electric field of the driving electrode 11 to correspondingly generate an electric field, and the mirror electrode 12 is driven to swing. The structure of the electrostatic MEMS scanning mirror 10 is similar to a large capacitor, and a rotation angle of the mirror electrode 12 (i.e. a rotation angle of the electrostatic MEMS scanning mirror 10) influences a capacitance of the electrostatic MEMS scanning mirror 10. Moreover, when the electrostatic MEMS scanning mirror 10 is stationary, the capacitance of the electrostatic MEMS scanning mirror 10 is not changed.

According to the above characteristic of the electrostatic MEMS scanning mirror 10, a following equation is deduced:

i=dQ/dt=C×dV/dt+V×dC/dt

Where, Q is an amount of charges stored by the electrostatic MEMS scanning mirror 10, t is time, C is the capacitance of the electrostatic MEMS scanning mirror 10, V is a cross voltage of the electrostatic MEMS scanning mirror 10. Moreover, when the cross voltage of the electrostatic MEMS scanning mirror 10 is a fixed value, the above equation can be evolved into a following equation:

i=dQ/dt=V×dC/dt

In other words, the current of the electrostatic MEMS scanning mirror 10 is response to the capacitance of the electrostatic MEMS scanning mirror 10.

In the present embodiment, the angle detection circuit 100 includes a capacitance sensing unit 110, a low-pass filter amplifier unit 120 and an angle determination unit 130. The capacitance sensing unit 110 is coupled to the mirror electrode 12 of the electrostatic MEMS scanning mirror 10 for sensing an equivalent capacitance of the electrostatic MEMS scanning mirror 10 according to the current iₛ caused by a coupling voltage of the mirror electrode 12 and the driving electrode 11 of the electrostatic MEMS scanning mirror 10, and providing a capacitance sensing signal SSC. The low-pass filter amplifier unit 120 is coupled to the capacitance sensing unit 110 for receiving the capacitance sensing signal SSC, and provides a position signal SPOS after performing a low-pass filtering and amplifying operation on the capacitance sensing signal SSC. The angle determination unit 130 is coupled to the low-pass filter amplifier unit 120 for receiving the position signal SPOS, and determines a rotation angle of the mirror electrode 12 of the electrostatic MEMS scanning mirror 10 to provide an angle signal SANG.

FIG. 1B is a schematic diagram of operation signals of the electrostatic

MEMS scanning mirror and the angle detection circuit of FIG. 1A. Referring to FIG. 1A and FIG. 1B, in which the same or similar components are denoted by the same or similar referential numbers. In the present embodiment, the driving signal SDR is, for example, a pulse signal, and the mirror electrode 122 is swung between a forward maximum rotation angle θₐ and a reverse maximum rotation angle θ_{b}. Since the rotation angle of the mirror electrode 12 influences a distance between the mirror electrode 12 and the driving electrode 11, the equivalent capacitance between the mirror electrode 12 and the driving electrode 11 is correspondingly changed. Further, when the rotation angle of the mirror electrode 12 is 0, the equivalent capacitance between the mirror electrode 12 and the driving electrode 11 reaches the maximum value.

According to the position signal SPOS provided by the low-pass filter amplifier unit 120 after performing the low-pass filtering and amplifying operation on the capacitance sensing signal SSC, the angle determination unit 130 can determine the rotation angle of the mirror electrode 12 of the electrostatic MEMS scanning mirror 10 according to a voltage level of the position signal SPOS, where the angle determination unit 130 can establish a look-up table to determine a corresponding relationship between the voltage level of the position signal SPOS and the rotation angle of the mirror electrode 12. Further, when the voltage level of the position signal SPOS presents a falling edge (shown by NE), the angle determination unit 130 determines the rotation angle of the mirror electrode 12 to be 0. When the voltage level of the position signal SPOS is at a middle voltage VM, the angle determination unit 130 sequentially determines the rotation angle of the mirror electrode 12 to be the forward maximum rotation angle θₐ and the reverse maximum rotation angle θ_{b}, i.e. at a time point T1, the angle determination unit 130 determines the rotation angle of the mirror electrode 12 to be the forward maximum rotation angle θₐ, and at a time point T2, the angle determination unit 130 determines the rotation angle of the mirror electrode 12 to be the reverse maximum rotation angle θ_{b}, and the others are deduced by analogy.

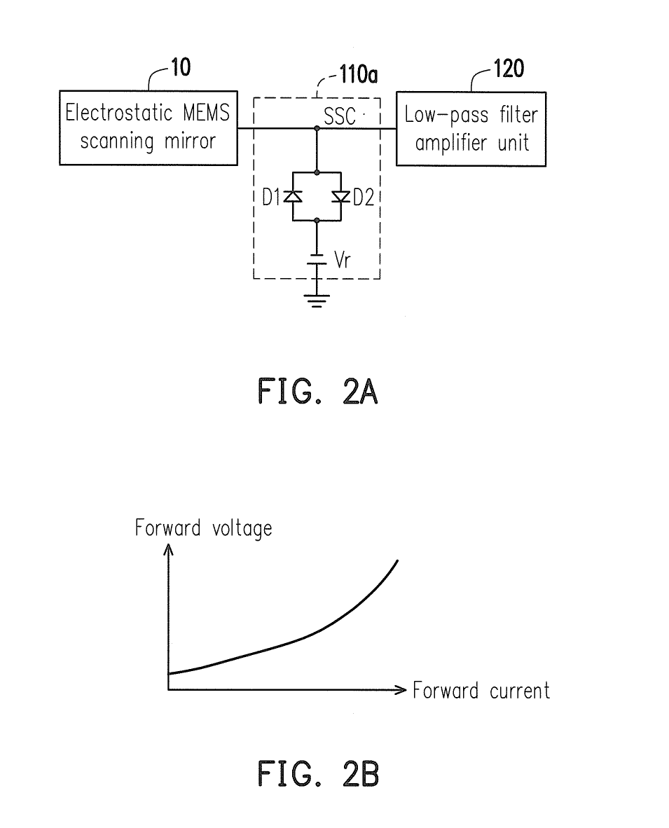

FIG. 2A is a circuit schematic diagram of the capacitance sensing unit of FIG. 1A according to an embodiment of the invention. Referring to FIG. 1A and FIG. 2A, in which the same or similar components are denoted by the same or similar referential numbers. In the present embodiment, the capacitance sensing unit 110a includes a reference voltage Vr, a first diode D1 and a second diode D2. An anode of the first diode D1 and a cathode of the second diode D2 are coupled to a first terminal of the reference voltage Vr. A cathode of the first diode D1 and an anode of the second diode D2 are coupled to the mirror electrode 12 and provide the capacitance sensing signal SSC to the low-pass filter amplifier unit 120. A second terminal of the reference voltage Vr is coupled to the ground.

Further, the reference voltage Vr serves as a basic voltage of the capacitance sensing unit 110a, for example, a ground voltage or a common voltage, and when the capacitance of the electrostatic MEMS scanning mirror 10 is changed, the current iₛ is correspondingly changed. In detail, the current iₛ is generated by the driving voltage SDR (AC square wave), and when the capacitance of the electrostatic MEMS scanning mirror 10 is decreased, it represents that when the mirror electrode 12 rotates from a rotation angle 0 (the capacitance has the maximum value, and the current iₛ is the maximum negative value) to the rotation angle (θₐ or θ_{b}), the capacitance drops from the maximum value, and the generated current iₛ is gradually increased from the maximum negative value. When the mirror electrode 12 reaches the forward maximum rotation angle θₐ or the reverse maximum rotation angle θ_{b}, the capacitance has a minimum value, and the current iₛ is 0. When the mirror electrode 12 rotates from the maximum rotation angle (θₐ or θ_{b}) to the rotation angle 0, the capacitance is increased from the minimum value, and the generated current iₛ is also gradually increased from 0. When the mirror electrode 12 reaches the rotation angle 0, the capacitance has the maximum value, and the current iₛ is increased to the maximum positive value. Therefore, when the current iₛ has the positive value (i.e. positive half cycle), the positive half cycle of the current iₛ flows to the reference voltage Vr through the second diode D2, and when the current iₛ has the negative value (i.e. negative half cycle), the negative half cycle of the current iₛ flows back from the reference voltage Vr through the first diode D1, and the voltage level of the capacitance sensing signal SSC at the moment is changed along with variation of the current iₛ, namely, the voltage level of the capacitance sensing signal SSC is changed along with variation of the capacitance of the electrostatic MEMS scanning mirror 10.

FIG. 2B is a schematic diagram of a current-voltage characteristic of the diode according to an embodiment of the invention. Referring to FIG. 2A and FIG. 2B, generally, the greater a forward current of the diode is, the higher a forward voltage of the diode is. According to the above description, the current iₛ of the mirror electrode 12 and the driving electrode 11 of the electrostatic MEMS scanning mirror 10 is response to the equivalent capacitance of the electrostatic MEMS scanning mirror 10, such that in the present embodiment of the invention, according to the forward current-voltage characteristic of the diodes D1 and D2, the variation of the current iₛ of the electrostatic MEMS scanning mirror 10 is converted to the capacitance sensing signal SSC, so as to obtain position information of the rotation angle of the mirror electrode 12.

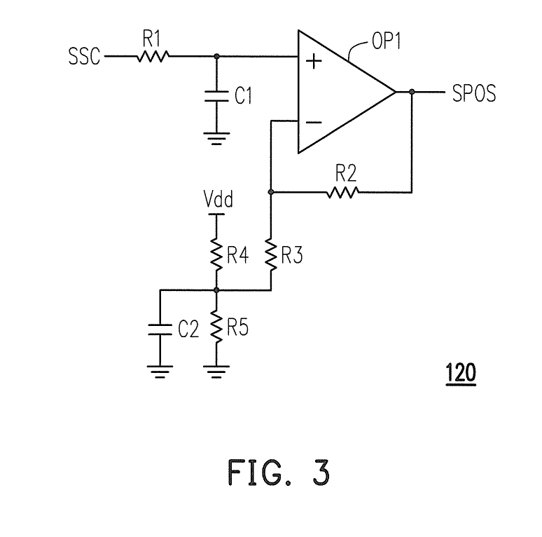

FIG. 3 is a circuit schematic diagram of a low-pass filter amplifier unit of FIG. 1A according to an embodiment of the invention. Referring to FIG. 1A and FIG. 3, in which the same or similar components are denoted by the same or similar referential numbers. In the present embodiment, the low-pass filter amplifier unit 120 includes an operational amplifier OP1, a first capacitor C1, a second capacitor C2, a first resistor R1, a second resistor R2, a third resistor R3, a fourth resistor R4 and a fifth resistor R5. An output terminal of the operational amplifier OP1 provides the position signal SPOS. The first capacitor C1 is coupled between a positive input terminal (corresponding to a first input terminal) of the operational amplifier OP1 and the ground voltage. The first resistor R1 is coupled between the capacitance sensing unit 110 and the positive input terminal of the operational amplifier OP1. The second resistor R2 is coupled between a negative input terminal (corresponding to a second input terminal) and the output terminal of the operational amplifier OP1. A terminal of the third resistor R3 is coupled to the negative input terminal of the operational amplifier OP1. The fourth resistor R4 is coupled between the other tell final of the third resistor R3 and a system voltage Vdd. The fifth resistor R5 is coupled between the other terminal of the third resistor R3 and the ground voltage. The second capacitor C2 is coupled between the other terminal of the third resistor R3 and the ground voltage.

In summary, in the angle detection circuit of the electrostatic MEMS scanning mirror of the invention, the capacitance sensing unit senses a variation of the equivalent capacitance of the electrostatic MEMS scanning mirror and correspondingly provides the capacitance sensing signal, and the low-pass filter amplifier unit performs a low-pass filtering and amplifying operation on the capacitance sensing signal to convert the capacitance sensing signal into the position signal. In this way, the rotation angle of the electrostatic MEMS scanning mirror can be accurately sensed.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A detection circuit, configured to detect an angle of an electrostatic micro-electro-mechanical system (MEMS) scanning mirror, comprising:
a capacitance sensing unit, coupled to a mirror electrode of the electrostatic MEMS scanning mirror, configured to sense an equivalent capacitance of the electrostatic MEMS scanning minor and provide a capacitance sensing signal;
a low-pass filter amplifier unit, coupled to the capacitance sensing unit for receiving the capacitance sensing signal, and providing a position signal; and
an angle determination unit, coupled to the low-pass filter amplifier unit, for receiving the position signal, determining a rotation angle of the mirror electrode of the electrostatic MEMS scanning mirror and providing an angle signal.

2. The detection circuit as claimed in claim 1, wherein the capacitance sensing unit senses the equivalent capacitance of the electrostatic MEMS scanning mirror according to a coupling current of the mirror electrode and a driving electrode of the electrostatic MEMS scanning mirror, so as to provide the capacitance sensing signal, wherein the driving electrode of the electrostatic MEMS scanning minor receives a driving signal.

3. The detection circuit as claimed in claim 2, wherein the capacitance sensing unit comprises:
a reference voltage, having a first terminal and a second terminal, wherein the second terminal receives a ground voltage;
a first diode, wherein a cathode of the first diode is coupled to the mirror electrode and provides the capacitance sensing signal, and an anode of the first diode is coupled to the first terminal of the reference voltage; and
a second diode, wherein an anode of the second diode is coupled to the mirror electrode, and a cathode of the second diode is coupled to the first terminal of the reference voltage.

4. The detection circuit as claimed in claim 1, wherein the low-pass filter amplifier unit comprises:
an operational amplifier, having a first input terminal, a second input terminal and an output terminal, wherein the output terminal provides the position signal;
a first capacitor, coupled between the first input terminal and a ground voltage;
a first resistor, coupled between the capacitance sensing unit and the first input terminal;
a second resistor, coupled between the second input terminal and the output terminal;
a third resistor, wherein a terminal of the third resistor coupled to the second input terminal;
a fourth resistor, coupled between the other terminal of the third resistor and a system voltage;
a fifth resistor, coupled between the other terminal of the third resistor and the ground voltage; and
a second capacitor, coupled between the other terminal of the third resistor and the ground voltage.

5. The detection circuit as claimed in claim 4, wherein the first input terminal is a positive input terminal, and the second input terminal is a negative input terminal.

6. The detection circuit as claimed in claim 1, wherein the angle determination unit determines the rotation angle of the mirror electrode of the electrostatic MEMS scanning mirror according to a voltage level of the position signal.

7. The detection circuit as claimed in claim 1, wherein when the voltage level of the position signal presents a falling edge, the angle determination unit determines the rotation angle of the mirror electrode to be 0, and when the voltage level of the position signal is at a middle voltage, the angle determination unit sequentially determines the rotation angle of the mirror electrode to be a forward maximum rotation angle and a reverse maximum rotation angle.

8. An angle detection circuit of an electrostatic MEMS scanning mirror, comprising:
an electrostatic MEMS scanning mirror, having a driving electrode receiving a driving signal;
a capacitance sensing unit, coupled to a mirror electrode of the MEMS scanning mirror, configured to sense an equivalent capacitance of the MEMS scanning mirror and provide a capacitance sensing signal;
a low-pass filter amplifier unit, coupled to the capacitance sensing unit for receiving the capacitance sensing signal, and providing a position signal; and
an angle determination unit, coupled to the low-pass filter amplifier unit for receiving the position signal, and determining a rotation angle of the mirror electrode of the MEMS scanning mirror to provide an angle signal.
